(19) United States
(12) Patent Application Publication
(10) Pub. No.: US 2008/0234413 A1
(43) Pub. Date: Sep. 25, 2008

(54) Polyacetal resin composition

(76) Inventors: Kenichi Shinohara, Tochigi (JP); Maiko Shibuya, Tochigi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/075,861

(22) Filed: Mar. 14, 2008

Related U.S. Application Data
(60) Provisional application No. 60/919,004, filed on Mar. 20, 2007.

(51) Int. Cl. C08K 5/3445

(52) U.S. Cl. 524/106

(57) ABSTRACT

A polyacetal resin composition of the present invention includes: a) a polyacetal resin, b) a high molecular weight silicone blended with a polyacetal resin, a high molecular weight silicone blended with an olefin resin, a polyolefin resin grafted to a silicone compound or a combination thereof, and c) an organic cyclic compound having an active imino group.

This application claims the benefit of U.S. Provisional Application No. 60/919,004, filed Mar. 20, 2007, which is incorporated herein by reference in its entirety.

### BACKGROUND OF THE INVENTION

1. Field of the Invention

The present invention relates to a polyacetal resin composition. More particularly, the present invention relates to a polyacetal resin composition having low friction, low wear and reduced generation of volatile organic compounds (VOC).

2. Description of the Related Art

Polyoxymethylene resin has balanced mechanical characteristics and superior wear resistance, and is widely used in various parts such as gears, sliders, switches, cams and clips of automobiles, electrical and electronic equipment, as well as in OA equipment and other applications. However, since the wear resistance alone of this polyoxymethylene resin itself is insufficient for use as a sliding material, sliding parts molded from this resin are used after applying grease to the sliding portions thereof. In addition, polyoxymethylene resin compositions have also been proposed which enable the molding of sliding parts which do not require the application of grease. One of these proposals consists of the addition of a silicone compound to a polyacetal resin as described below.

A self-lubricating resin composition is disclosed in U.S. Pat. No. 4,874,807 in which a silicone oil having a viscosity of 150,000 centistokes (cSt) or more is added to a thermoplastic resin such as a polyacetal resin.

U.S. Pat. No. 4,879,331 discloses a polyacetal resin composition capable of improving wear resistance by adding a silicone oil having a viscosity of 150,000 cSt or more and a lubricating oil having a viscosity of 3,000 cSt or less to a thermoplastic resin such as a polyacetal resin.

Japanese Patent Application Laid-open No. H11-279421 discloses a self-lubricating resin composition in which a silicone rubber having a viscosity of 1,000,000 cSt or more is added to a thermoplastic resin such as a polyacetal resin.

Japanese Patent Application Laid-open No. H4-234450 discloses a self-lubricating resin composition in which a silicone rubber having a viscosity of 1,000,000 cSt or more and a polytetrafluoroethylene resin are added to a thermoplastic resin such as a polyacetal resin.

U.S. Pat. No. 5,824,742 discloses a resin composition enabling wear resistance and reduction of sliding noise by adding a dimethylsiloxane polymer to a thermoplastic resin such as a polyacetal resin, and further adding an olefin resin having a glycidyl group.

U.S. Pat. No. 6,602,953 discloses a polyacetal resin composition capable of providing molded products having good moldability and for which sliding characteristics are not impaired even by contact with solvents, by containing a polyolefin resin grafted by a silicone compound and a silicone compound at a predetermined ratio in a polyacetal resin.

More recently, there are a growing number of regulations relating to the reduction of volatile organic compounds (VOC) due to concern over volatile organic compounds volatilized from parts molded from compositions containing polyacetal resins causing environmental contamination as a result of contaminating the living environment. From this viewpoint, U.S. Pat. No. 5,866,671 discloses a resin composition used in molded parts for photographic photosensitive materials for the purpose of reducing a volatile compound in the form of formaldehyde generated from polyacetal resin compositions.

As has been described in each of the above documents, organosiloxane polymers such as silicone oil or silicone rubber are known to enhance self-lubrication, reduce friction and remarkably improve wear resistance by being added to a thermoplastic resin such as a polyacetal resin. More recently, the generation of volatile organic compounds (VOC), and particularly formaldehyde, is being required to be curtailed. In addition, volatile organic compounds have also been pointed out to cause corrosion of wiring boards used in electrical and electronic components, as well as deterioration of light transmission properties (in the form of clouding and so on) of magnetic media (such as CD and DVD).

Thus, there is a desire for a plastic material (polyacetal material) having low friction and low wear while also minimizing the generation of volatile organic compounds, and there is a need for a polyacetal resin composition capable of providing such materials.

### BRIEF SUMMARY OF THE INVENTION

A polyacetal resin composition of the present invention comprises: a) a polyacetal resin, b) a silicone composition selected from the group consisting of: (i) a high molecular weight silicone polymer blended with a polyacetal resin, (ii) a high molecular weight silicone polymer blended with an olefin resin, (iii) a polyolefin resin grafted to a silicone compound and (iv) a combination of at least two of (i), (ii) and (iii), and c) an organic cyclic compound having an active imino group.

A polyacetal resin composition of the present invention contains 0.5 to 5 parts by weight of component b) and 0.02 to 3 parts by weight of component c) with respect to 100 parts by weight of component a).

In addition, the organic cyclic compound having an active imino group is preferably a hydantoin represented by the following formula (I):

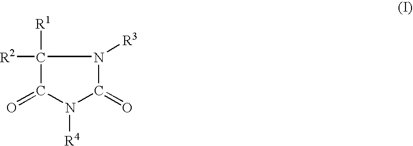

wherein, R¹ represents —H, —CH₃ or —NH—C(═O)—NH₂, R² represents —H, —CH₃ or —NH—C(═O)—NH₂, R³ represents —H or —CH₂OH, R⁴ represents —H or —CH₂OH, and at least one of R³ and R⁴ represents —H. In the present invention, the organic cyclic compound having an active imino group is particularly preferably hydantoin, dimethylhydantoin or allantoin.

Preferably, the component b) is the high molecular weight silicone blended with a polyacetal resin or a high molecular weight silicone blended with an olefin resin, and the content of the high molecular weight silicone polymer in the master batch is 30 to 60 parts by weight based on the total weight of the master batch.

According to the present invention, a polyacetal resin composition can be provided which has low friction and low wear, and inhibits the generation of volatile organic compounds.

### BRIEF DESCRIPTION OF THE DRAWINGS

FIG. 1 is a drawing showing the structures of test pieces used in the examples; and,

FIG. 2 is a schematic drawing showing the configuration of a wear measuring system used in the examples.

### DETAILED DESCRIPTION OF THE INVENTION

The present invention relates to a polyacetal resin composition comprising a) a polyacetal resin, b) 0.5 to 5 parts by weight of a high molecular weight silicone polymer blended with a polyacetal resin, a high molecular weight silicone polymer blended with an olefin resin, a polyolefin resin grafted to a silicone compound, or a combination thereof, and c) 0.02 to 3.00 parts by weight of an organic cyclic compound having an active imino group selected from hydantoins.

In addition to the polyacetal resin, the polyacetal resin composition of the present invention uses b) a high molecular weight silicone polymer blended with a polyacetal resin, a high molecular weight silicone polymer blended with an olefin resin, a polyolefin resin grafted to a silicone compound, or a combination thereof, and contains c) a hydantoin. The composition of the present invention realizes low friction characteristics and low wear characteristics as a result of containing the component b), and is able to minimize the generation of volatile organic compounds as a result of containing the component c). Moreover, in the present invention, it was found that the combined use of the component b) and the component c) makes it possible to expect synergistic effects for further improving wear resistance beyond that of the case of using the component b) alone.

The following provides an explanation of each component of the polyacetal resin composition of the present invention.

### a) Polyacetal Resin

Examples of polyacetal resins used in the polyacetal resin composition of the present invention include ordinary polyacetal resins such as aldehydes such as, formaldehyde, trioxane, a cyclic oligomer of formaldehyde, homopolymers such as tetraoxane or copolymers thereof, and copolymers of these aldehydes, cyclic ethers or acetals such as ethylene oxide, propylene oxide or 1,3-dioxiolane.

The polyacetal resin may be a homopolymer or copolymer. In the case of using a copolymer, the addition of both the component b) and the component c) results in greater effects for improving wear resistance than in the case of using the component b) alone. In other words, synergy can be expected as a result of using the component b) and the component c).

These polyacetal resins are linear polymers having a number average molecular weight of 10,000 to 100,000 and preferably 20,000 to 70,000 having a main chain comprised of a repeating unit(s) represented by —(CH₂O)ₙ— (wherein, n represents a positive integer) and/or —(CHR—O)ₙ— (wherein, R represents an alkyl group and n represents a positive integer), and the ends are either unprotected or protected with protecting groups such as —OCOCH₃, —OCH₃— or —OCH₂—OH.

An example of such a polyacetal resin is Delrin (registered trademark) polyacetal resin manufactured by E. I. du Pont de Nemours and Company.

Furthermore, the content of polyacetal resin in the composition of the present invention is the amount remaining after excluding the content of components other than the polyacetal resin to be described later.

b) High Molecular Weight Silicone Blended with Polyacetal Resin, High Molecular Weight Silicone Blended with Olefin Resin, or Polyolefin Resin Grafted by Silicone

In the present invention, a high molecular weight silicone blended with polyacetal resin, a high molecular weight silicone blended with olefin resin, a polyolefin resin grafted to a silicone compound or a combination thereof is used for component b). These are able to increase compatibility between the polyacetal resin and high molecular weight silicone.

The product obtained from kneading a gummy high molecular weight silicone polymer into a polyacetal resin to a high concentration is included in the high molecular weight silicone blended with polyacetal resin.

The content of the high molecular weight silicone polymer in the master batch is preferably 30 to 60 parts by weight based on the total weight of the master batch (based on 100 parts by weight for the entire master batch). The same types of homopolymers as those explained in the above-mentioned section a) can be used as a polyacetal homopolymer able to be used for the high molecular weight silicone blended with polyacetal resin. Alternatively, a different type of polyacetal homopolymer can also be used. In addition, another example of a high molecular weight silicone able to be used is a gummy polymer. More specifically, a high molecular weight silicone having plasticity as defined in JIS K6300 or ASTM D926 of 0.65 or more is used preferably. This is because, if silicone having a high level of plasticity is used, the silicone continues to be dispersed in the olefin resin in a preferable state, thereby enhancing the effects of silicone addition. An example of a high molecular weight silicone polymer used in this master batch is BY16-140 manufactured by Dow Corning Toray Co., Ltd.

In addition, the polyacetal resin is not required to be a homopolymer, but rather various types of copolymer polyacetal resins can be used corresponding to the component a) used in the composition of the present invention.

The product of kneading a high molecular weight silicone polymer into an olefin resin to a high concentration is included in the high molecular weight silicone blended with an olefin resin.

Examples of olefins able to be used include general-purpose olefin resins such as polypropylene (PP), polyethylene (PE), polymethyl acrylate (PMA) and polymethyl methacrylate (PMMA). In addition, an example of a high molecular weight silicone able to be used is a previously described gummy polymer. An example of a commercial product of a master batch able to be used in the present invention is BY27-002 manufactured by Dow Corning Toray Co., Ltd.

The content of high molecular weight silicone of the high molecular weight silicone blended with the olefin resin is preferably 30 to 60 parts by weight based on the total weight of the master batch (based on 100 parts by weight for the entire master batch). If the content exceeds 60 parts by weight, it becomes impossible to finely disperse the silicone in the polyacetal resin composition, while if the content is less than 30% by weight, there is the risk of the effects of the present invention being unable to be demonstrated.

The polyolefin resin grafted to a silicone compound is the product of graft polymerization of a compound represented by a polydimethylsiloxane having an average degree of polymerization of 1000 to 10000 shown in the following formula (II) to polyolefin resin such as low-density polyethylene, linear low-density polyethylene, high-density polyethylene, ethylene-vinyl acetate copolymer, ethylene-methyl methacrylate copolymer, ethylene-ethyl acrylate copolymer, polymethylpentene, polypropylene or tetrafluoroethylene-ethylene copolymer (and a small amount of a vinyl monomer such as vinyl acetate may be contained as necessary). As described in Japanese Patent Publication No. S52-36898, this polyolefin resin grafted to silicone can be produced by melting and kneading the polyolefin resin and silicone gum in the presence of an organic peroxide, UV rays, gamma rays and sulfur under specific temperature and shear conditions. In addition, a similar technology is indicated in Japanese Patent Publication No. S56-1201. In addition, a method may also be used in which a polymer is graft polymerized to a silicone compound using a catalyst as proposed in Japanese Patent Publication No. H643472.

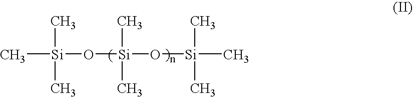

In this formula, the methyl groups may be substituted with a substituent having a hydrogen atom, alkyl group, phenyl group, ether group, ester group, or a reactive substituent in the form of a hydroxyl group, amino group, epoxy group, carboxyl group, carbinol group, methacrylic group, mercapto group, phenol group, vinyl group, allyl group, polyether group or fluorine-containing alkyl group, and a substituent having a vinyl group or allyl group is preferable for grafting, while a substituent having a vinyl group is more preferable.

The ratio between the polyolefin resin and silicone gum of the polyolefin resin grafted to the silicone is within the range of a weight ratio of 80/20 to 20/80, and preferably within the range of a weight ratio of 70/30 to 30/70.

In the polyacetal resin composition of the present invention, the content of the component b) is preferably 0.5 to 5 parts by weight with respect to 100 parts by weight of the polyacetal resin.

### c) Organic Cyclic Compound Having an Active Imino Group

In the present invention, an organic cyclic compound having an active imino group is added to the polyacetal resin composition to minimize the generation of volatile organic compounds (VOC).

An example of an organic cyclic group having an active imino group able to be used is a compound represented by the following general formula (III). General formula (III) indicates a cyclic organic compound in which R¹, R² and R³ represent divalent organic radicals and are respectively formed by covalent bonds.

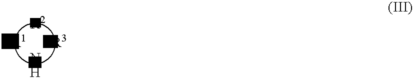

The active imino compound is preferably that which has a high capacity to form a methylol group by reacting with formaldehyde as shown in the following reaction formula (IV) in the process in which the polyacetal resin solidifies by crystallization and following solidification, due to the high level of reactivity of the imino group thereof.

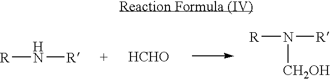

(R— and R′— represent monovalent organic radicals.)

The Imino Group is Required to have a Sufficiently Low Electron Density and cause an electron nucleophilic reaction in order to have this reactivity. Consequently, it is necessary for the organic radicals directly chemically bonded to the imino group to attract electrons. These organic radicals, namely the organic radicals indicated with R¹, R² and R³ in the general formula (I), are preferably compounds having a —CO—, —COO—, —NH—, —NH₂, phenyl group, biphenyl group or naphthalene group at locations bonded to the imino group.

Moreover, in the case of adding a compound to the polyacetal resin, that compound must be released by melting and mixing or undergo thermal degradation. Examples of organic cyclic compounds having an active imino group which satisfy these requirements include hydantoins and imidazole compounds. In the present invention, a hydantoin compound represented by general formula (I) is preferable.

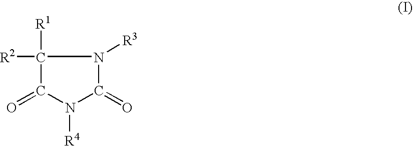

In this formula, R¹ represents —H, —CH₃ or —NH—C(═O)—NH₂, R² represents —H, —CH₃ or —NH—C(═O)—NH₂, R³ represents —H or —CH₂OH, R⁴ represents —H or —CH₂OH, and at least one of R³ and R⁴ represents —H. In the present invention, examples hydantoin compounds include, but are not limited to, hydantoin, dimethyl hydantoin (e.g., 5,5-dimethylhydantoin) and allantoin.

Hydantoins are preferable in the present invention since they have characteristics such as having large VOC reducing effects, are stable at the process temperature, and have high stability as a compound.

The proportion of the organic cyclic compound having an active imino group in the composition of the present invention is 0.02 to 3 parts by weight, preferably 0.03 to 2 parts by weight, and more preferably 0.04 to 1 parts by weight.

In addition, various additives can be added to the polyacetal resin composition of the present invention to improve various characteristics within a range that does not impair the characteristics of the polyacetal resin, examples of which include heat stabilizers, antioxidants, ultraviolet absorbers, photostabilizers, plasticizers, release agents, inorganic fillers and pigments.

The polyacetal resin composition of the present invention can be easily prepared according to known methods, such as by thoroughly mixing each of the above-mentioned components followed by melting and kneading using a single-screw or double-screw extruder to prepare pellets.

Various types of molded products having the characteristics of the present invention can be obtained by molding pellets of each of resin composition of the present invention in accordance with ordinary methods such as injection molding.

### EXAMPLES

The following provides a more detailed explanation of the present invention through examples thereof. Furthermore, in the examples, the units for the amounts of materials used and so on are parts by weight unless specifically indicated otherwise.

### 1) Preparation of Polyacetal Resin Composition

The following materials were used for each component of the polyacetal resin composition.

a) Polyacetal Resins

POM-1: Polyoxymethylene homopolymer (Melt flow rate: 10.5 g/min) (trade name: Delrin (registered trademark) 500P NC010 (DuPont).

POM-2: Polyoxymethylene copolymer (melt flow rate: 9.0 g/min) (trade name: Delrin (registered trademark) 460NC010 (DuPont).

b) High Molecular Weight Silicone Blended with Polyacetal Resin, High Molecular Weight Silicone Blended with Olefin Resin or Olefin Resin Grafted by Silicone

L-1: Silicone master batch in which 50 parts by weight of gummy high molecular weight silicone polymer (plasticity: 1.5) are melted, kneaded and dispersed in 50 parts of polyacetal copolymer resin (melt flow rate: 9.0 g/min, trade name: BY27-006, Dow Corning Toray).

L-2: Silicone master batch in which 50 parts by weight of gummy high molecular weight silicone polymer are added to 50 parts of low-density polyethylene resin followed by melting, kneading and dispersion (product name: BY27-002, Dow Corning Toray, melt flow rate: 6 g/min).

L-3: Olefin resin grafted to silicone in which high molecular weight silicone polymer (40 parts by weight) is grafted to low-density polyethylene resin (60 parts by weight) (grafting ratio: ca. 85%, product name: BY27-213, Dow Corning Toray, melt flow rate: 0.09 g/min).

c) Organic Cyclic Compound Having an Active Imino Group

M-1: 5,5-dimethylhydantoin

M-2: Allantoin

### Example 1

315 g of a polyacetal resin-based silicone master batch (L-1) and 10.5 g of 5,5-dimethylhydantoin (M−1) were added to 7000 g of a polyoxymethylene homopolymer resin (POM-1) followed by mixing, melting and kneading with a 40 mm single-screw extruder and cutting to obtain a composition in the form of pellets. The resin processing temperature was 200° C. The amount of silicone only added at that time was 1.8 parts by weight with respect to 100 parts by weight of the composition.

### Examples 2 to 7

Compositions in the form of pellets were obtained by changing the types and amounts added of component b) (L) and component c) (organic cyclic compound having an active imino group) in the form of a formaldehyde trapping agent (M) in the composition of Example 1 as shown in Table 1, followed by melting and kneading the mixtures with a 40 mm single-screw extruder in the same manner as Example 1 and cutting. The resin processing temperature was 200° C. in the same manner as Example 1. The amount of silicone only added at that time was 1.8 parts by weight with respect to 100 parts by weight of the composition in all cases.

### Example 8

252 g of a silicone master batch (L-2) and 10.5 g of allantoin (M−2) were added to 7000 g of a polyoxymethylene copolymer resin (POM-2) followed by mixing, melting and kneading with a 40 mm single-screw extruder and cutting to obtain a composition in the form of pellets. The resin processing temperature was 190° C.

### Comparative Example 1

A composition in the form of pellets was obtained by kneading and melting 7000 g of a polyoxymethylene homopolymer resin (POM-1) with a 40 mm single-screw extruder followed by cutting. The processing temperature was 200° C.

### Comparative Examples 2 to 5

Compositions in the form of pellets were obtained by changing the types and amounts added of component b) (L) and component c) (organic cyclic compound having an active imino group) in the form of a formaldehyde trapping agent (M) in the composition of Comparative Example 1 as shown in Table 2, followed by melting and kneading the mixtures with a 40 mm single-screw extruder and cutting. The processing temperature was 200° C.

### Comparative Example 6

252 g of a silicone master batch (L-2) were added to 7000 g of a polyoxymethylene copolymer resin (POM-2) followed by mixing, melting and kneading with a 40 mm single-screw extruder and cutting to obtain a composition in the form of pellets. The resin processing temperature was 190° C.

TABLE 1

| | Unit | Ex. 1 | Ex. 2 | Ex. 3 | Ex. 4 | Ex. 5 | Ex. 6 | Ex. 7 | Ex. 8 |
|---|---|---|---|---|---|---|---|---|---|
| POM-1 | Parts by weight | 100 | 100 | 100 | 100 | 100 | 100 | 100 | |
| POM-2 | Parts by weight | | | | | | | | 100 |
| L-1 | Parts by weight | 3.6 | | | | | | | |
| L-2 | Parts by weight | | 3.6 | 3.6 | 1.80 | | 3.6 | 3.6 | 3.6 |
| L-3 | Parts by weight | | | | 2.25 | 4.5 | | | |
| M-1 | Parts by weight | 0.1 | 0.1 | | 0.05 | | 0.02 | 0.5 | |
| M-2 | Parts by weight | | | 0.1 | 0.05 | 0.1 | | | 0.1 |
| Total | Parts by weight | 103.70 | 103.70 | 103.70 | 104.15 | 104.60 | 103.68 | 104.10 | 103.70 |

TABLE 2

| | Unit | Comp. Ex. 1 | Comp. Ex. 2 | Comp. Ex. 3 | Comp. Ex. 4 | Comp. Ex. 5 | Comp. Ex. 6 |
|---|---|---|---|---|---|---|---|
| POM-1 | Parts by weight | 100 | 100 | 100 | 100 | 100 | |
| POM-2 | Parts by weight | | | | | | 100 |
| L-1 | Parts by weight | | | 3.6 | | | |
| L-2 | Parts by weight | | | | 3.6 | | 3.6 |
| L-3 | Parts by weight | | | | | 4.5 | |
| M-1 | Parts by weight | | 0.15 | | | | |
| M-2 | Parts by weight | | | | | | |
| Total | Parts by weight | 100.00 | 100.15 | 103.60 | 103.60 | 104.50 | 103.60 |

### 2) Evaluation

Each of the compositions of the examples and comparative examples were evaluated in the manner described below.

### i) Measurement of Amount of Volatilized Formaldehyde

Each of the pellets obtained in the examples and comparative examples were molded into plates measuring 100×80×2 mm using a 2.8-ounce injection molding machine (Sumitomo Heavy Metal Industries, SE100D) under standard molding conditions for polyacetal resins. After air-cooling the resulting plates, each plate was placed in a paper bag internally coated with aluminum, after which the paper bag was sealed and allowed to stand for 1 week at room temperature. Subsequently, the plates were removed from the bags and placed in a 4-liter Tedlar® bag followed by the addition of 2 liters of nitrogen gas and sealing. This bag was then placed in an oven heated to 65° C. and left in the oven for 2 hours. After removing from the oven, all of the gas inside was fed into a formaldehyde absorption cartridge (GL-PaK mini AERO DNPH) to absorb the formaldehyde, followed by storing in a refrigerator until the time of measurement. Measurement of the amount of formaldehyde was carried out by liquid chromatography (Shinaz LC-6A System, column: Intersil ODS-3 (5 μm×4.5 m×150 mm) using acetonitrile-water (60:40) for the mobile phase at a detection wavelength of 350 nm.

The results obtained were indicated as the value obtained by dividing the total amount of volatilized formaldehyde by the weight of the test piece (mg/kg).

### ii) Measurement of Amount of Wear

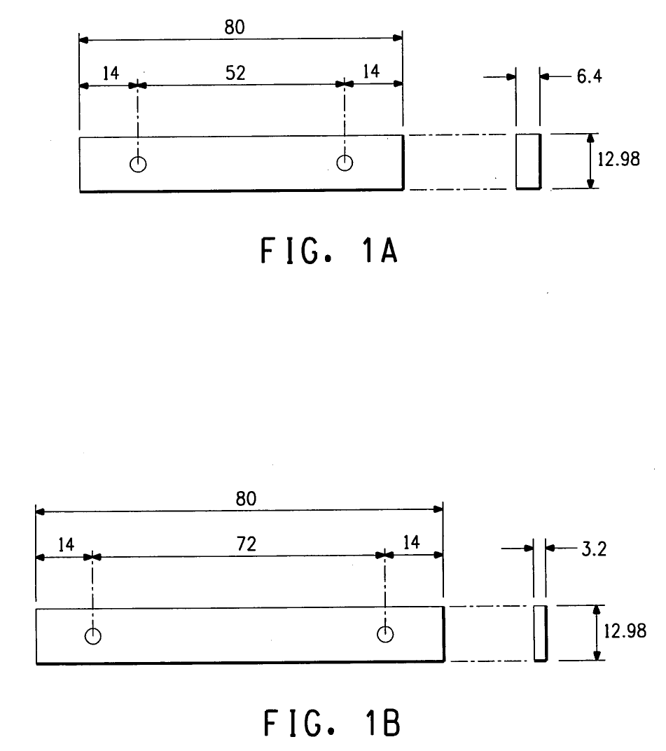

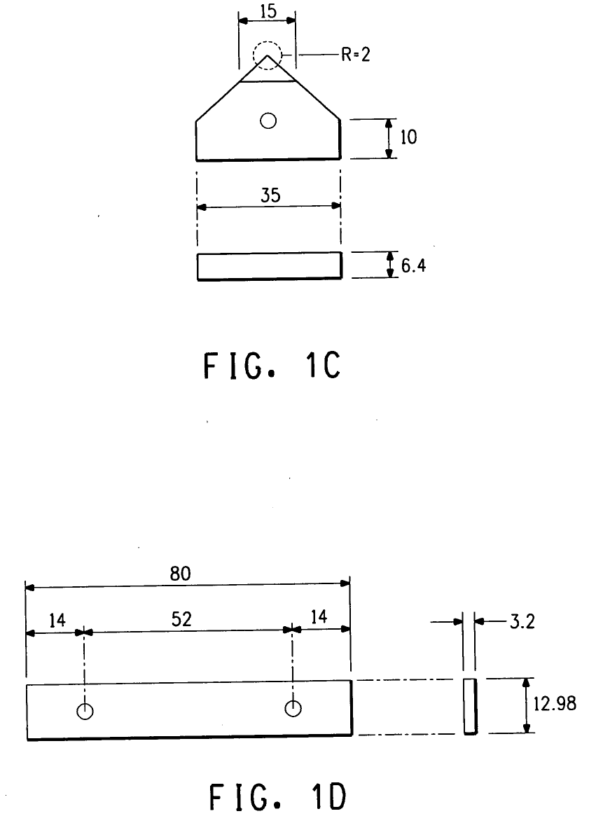

Test pieces were produced from each of the pellets obtained in the examples and comparative examples using a 2.8-ounce injection molding machine (Sumitomo Heavy Metal Industries, SE100D) under the same conditions as the above-mentioned standard molding conditions for polyacetal resins. The test pieces were molded into a flat plate B having a height of 12.98 mm, width of 100 mm and thickness of 3.2 mm as shown in FIG. 1B, and a pentagonal test piece C having a thickness of 6.4 mm and a tip of R=2 as shown in FIG. 1C. Flat plate B and pentagonal test piece C were placed in a room at a temperature of 23° C. and humidity of 50% so that the change in weight thereof was within 1 mg.

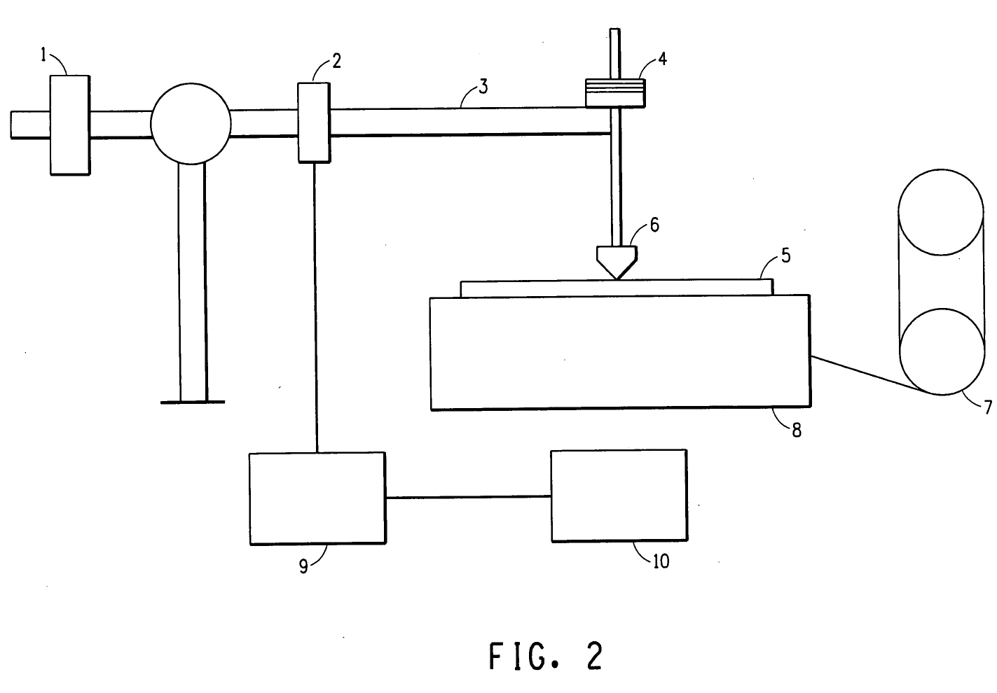

After the weights of the test pieces had stabilized, the amount of wear was measured with a wear measuring system (Suga Test Instruments Co., Ltd. FR-T) having a configuration like that shown in FIG. 2. As shown in FIG. 2, the measuring system is composed of a longitudinally reciprocating table (8) and an arm (3) able to be balanced with weights. A plate member B (5) is fixed to the reciprocating table (8). The reciprocating table (8) with the plate member B (5) fixed thereto is reciprocated forward and backward at a fixed cycle by a rotating disk (7) coupled thereto. On the other hand, a pentagonal test piece C (6) is fastened to one end of the arm, weights (4) are placed thereon to enable adjustment of the load. The pentagonal test piece C (6) fastened to the end of the arm (3) slides over the flat plate B (5) fixed to the reciprocating table (8) when the reciprocating table (8) begins reciprocal movement. Moreover, as shown in FIG. 2, the measuring system also contains a balance adjuster (1), a pressure sensor (2), a computer (9) and a recorder (19).

Measurement was carried out by reciprocating flat plate B 10,800 times at a stroke length of 130 mm using a load of 2 kgf. Following testing, the test place B and pentagonal test piece C were again placed in a room at a temperature of 23° C. and humidity of 50% for 1 week after testing, and after their weights had stabilized, flat plate B and pentagonal test piece C were weighed. Furthermore, since the wear measuring system was not in an environment at a temperature of 23° C. and 50% humidity, different flat plates B and pentagonal test pieces C were prepared using the compositions of Examples 1 to 8 and Comparative Examples 1 to 6, and the changes in weight thereof before and after testing were measured to serve as a control.

The amount of wear is represented with the following equation (V).

Amount of wear=(WCi−WCa−WCcv)+(WBi−WBa−WBcv) (V)
WCi: Initial weight of pentagonal test piece C (g)
WCa: Weight of pentagonal test piece C after testing (g)
WCcv: Change in weight of pentagonal test piece C before and after testing (g)
WBi: Initial weight of flat plate B (g)
WBa: Weight of flat plate B after testing (g)
WBcv: Change in weight of flat plate B before and after testing (g)
   iii) Measurement of Dynamic Friction Coefficient

Test pieces were produced from each of the pellets obtained in the examples and comparative examples using a 2.8-ounce injection molding machine (Sumitomo Heavy Metal Industries, SE100D) under the same conditions as the above-mentioned standard molding conditions for polyacetal resins. The test pieces were molded into a flat plate D having a height of 12.98 mm, width of 80 mm and thickness of 3.2 mm as shown in FIG. 1D, and a pentagonal test piece C having a thickness of 6.4 mm and a tip of R=2 as shown in FIG. 1C. Flat plate D and pentagonal test piece C were placed in a room at a temperature of 23° C. and humidity of 50% so that the change in weight thereof was within 1 mg.

After the weights of the test pieces had stabilized, the dynamic friction coefficients were measured at a load of 20 N, reciprocating speed of 60 cycles/min and stroke distance of 10 mm using a dynamic friction coefficient measuring system (JT Tohsi Inc., MST-50/100).

The measuring system employed a configuration as shown in FIG. 2, and flat plate D (5) is fixed to a reciprocating table (8). Pentagonal test piece C (6) is fastened to one end of an arm (3), and weights (4) are placed thereon. The pentagonal test piece C (6) fastened to the end of the arm (3) slides over the flat plate D (5) fixed to the reciprocating table (8) when the reciprocating table (8) begins reciprocal movement, and the dynamic frictional force at this time is measured by a pressure sensor (2) provided on the arm (3).

Measurement was carried out by continuing reciprocating movement of the reciprocating table (8) under the above-mentioned conditions for 25 minutes, and reading the value on the pressure sensor at 1 minute intervals. The dynamic frictional force was taken to be the mean value of measured pressure sensor readings.

The dynamic friction coefficient (μ′) is calculated using the following equation (VI).

μ′=F/N=F/20 (VI)
F=Dynamic frictional force (N)
N=Vertical drag (N)=20 N

### 3) Results

The results of the above-mentioned evaluations are shown in Tables 3 and 4.

TABLE 3

| | Unit | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Volatilized formaldehyde | Mg/kg | 0.7 | 0.8 | 0.3 | 0.4 | 0.3 | 7.2 | 0.5 | 0.04 |
| Friction coefficient | — | 0.09 | 0.08 | 0.08 | 0.04 | 0.05 | 0.08 | 0.06 | 0.07 |
| Amount of wear | Mg | 0.6 | 1.6 | 1.6 | 0.4 | 0.5 | 1.4 | 1.7 | 0.3 |

TABLE 4

| | Unit | Comp. Ex. 1 | Comp. Ex. 2 | Comp. Ex. 3 | Comp. Ex. 4 | Comp. Ex. 5 | Comp. Ex. 6 |
|---|---|---|---|---|---|---|---|
| Volatilized | mg/kg | 10.3 | 1.0 | 10.8 | 11.5 | 8.5 | 1.6 |
| formaldehyde | | | | | | | |
| Friction coefficient | — | 0.44 | 0.38 | 0.10 | 0.09 | 0.06 | 0.11 |
| Amount of wear | Mg | 1371.0 | 1052 | 0.3 | 1.7 | 0.4 | 1.8 |

### 4) Discussion

As a result of adding a master batch in which high molecular weight silicone was dispersed to a polyacetal resin, the friction coefficients and amounts of wear of molded products formed from compositions of the present invention decreased considerably, and demonstrated satisfactorily low friction and low wear. Moreover, as a result of adding a prescribed organic cyclic compound having an active imino group, the amount of volatile formaldehyde gas generated from molded products formed from compositions of the present invention was able to be reduced considerably without impairing friction or wear characteristics.

Moreover, as can be seen in Comparative Example 6 and Example 8, when a silicone master batch and formaldehyde absorber in the form of an organic cyclic compound having an active imino group are used in combination, synergistic effects can be expected which further improve wear resistance as compared with using the silicone master batch alone. These synergistic effects are particularly prominent in the case of using a polyacetal copolymer.

According to the results of Examples 2, 3, 6 and 7, the amount added of a formaldehyde trapping agent in the form of an organic cyclic compound having an active imino group is preferably 0.02 to 3 parts by weight, more preferably 0.03 to 2 parts by weight, and even more preferably 0.04 to 1 parts by weight.

What is claimed is:

1. A polyacetal resin composition comprising:
a) 100 parts by weight of a polyacetal resin:
b) 0.5 to 5.0 parts by weight of a silicone composition selected from the group consisting of: (i) a high molecular weight silicone polymer blended with a polyacetal resin, (ii) a high molecular weight silicone polymer blended with an olefin resin, (iii) a polyolefin resin grafted to a silicone compound and (iv) a combination of at least two of (i), (ii) and (iii): and
c) 0.02 to 3 parts by weight of an organic cyclic compound having an active imino group.

2. The polyacetal resin composition according to claim 1, wherein there is 0.03 to 2 parts by weight of the organic cyclic compound having an active imino group.

3. The polyacetal resin composition according to claim 1, wherein there is 0.04 to 1 part by weight of the organic cyclic compound having an active imino group.

4. The polyacetal resin composition according to claim 1, wherein the organic cyclic compound having an active imino group is a hydantoin represented by the following formula (I): 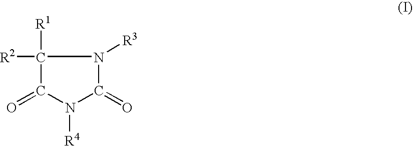
(wherein, R¹ represents —H, —CH₃ or —NH—C(═O)—NH₂, R² represents —H, —CH₃ or —NH—C(═O)—NH₂, R³ represents —H or —CH₂OH, R⁴ represents —H or —CH₂OH, and at least one of R³ and R⁴ represents —H).

5. The polyacetal resin composition according to claim 4, wherein the organic cyclic compound having an active imino group is hydantoin, dimethylhydantoin or allantoin.

6. The polyacetal resin composition according to claim 5, wherein the organic cyclic compound having an active imino group is 5,5-dimethylhydantoin or allantoin.

7. The polyacetal resin composition according to claim 1, wherein the silicone composition is the high molecular weight silicone polymer blended with a polyacetal resin or the high molecular weight silicone polymer blended with an olefin resin and the silicone composition is prepared in a master batch containing 30 to 60 parts by weight of the high molecular weight silicone polymer based on the total weight of the master batch.

8. The polyacetal resin composition according to claim 7, wherein the organic cyclic compound having an active imino group is 5,5-dimethylhydantoin or allantoin.

9. The polyacetal resin composition according to claim 1, wherein the silicone composition is the polyolefin resin grafted to a silicone compound and the ratio of the weights of the polyolefin resin and the silicone compound is between 80/20 and 20/80.
